(19) United States
(12) Patent Application Publication
(10) Pub. No.: US 2014/0278578 A1
(43) Pub. Date: Sep. 18, 2014

(54) System and Method for Conducting On-Site Asset Investigations for Insurance Underwriting

(71) Applicant: INSURANCE SERVICES OFFICE, INC., Jersey City, NJ (US)

(72) Inventors: John Cantwell, Ardmore, PA (US); Dorothy Ziegelbauer, Tuxedo, NY (US)

(73) Assignee: INSURANCE SERVICES OFFICE, INC., Jersey City, NJ (US)

(21) Appl. No.: 14/205,895

(22) Filed: Mar. 12, 2014

Related U.S. Application Data
(60) Provisional application No. 61/793,693, filed on Mar. 15, 2013.

(51) Int. Cl. G06Q 40/08

(52) U.S. Cl. CPC G06Q 40/08
USPC 705/4

(57) ABSTRACT

A system and method for conducting on-site asset investigations for insurance underwriting are provided. The system allows a user to conduct an investigation into an asset to be insured while at the asset's location, using a mobile software application executing on a mobile computing device such as smart phone, tablet computer, etc. The mobile application allows the user to acquire information relating to the asset as well as to take photographs of the vehicle or other personal property to be insured, using the mobile computing device. The acquired information is transmitted to an underwriting computer server in communication with the mobile device, which processes the information and generates an underwriting report for the asset.

### RELATED APPLICATIONS

The present application claims the benefit of U.S. Provisional Application Ser. No. 61/793,693 filed Mar. 15, 2013, the entire disclosure of which is expressly incorporated herein by reference.

### BACKGROUND

1. Related Art

The present invention relates to computer-based systems for investigating assets such as vehicles. More specifically, the present invention relates to a system and method for conducting on-site asset investigations for insurance underwriting.

2. Related Art

Conducting thorough investigations of assets to be insured is a critical function of insurance underwriting. Indeed, if proper investigations of assets are not carried out, insurance carriers can expend significant financial resources, as well as time and effort, in connection with insuring assets whose value may not be truly represented by an insurance applicant. As such, proper valuation of assets is key to successful insurance underwriting.

Increasingly, digital devices such as smart phones, laptop computers, tablet computers, etc., play an important role in today's society. Due to the rich features provided by such devices, such as wireless data connectivity, built-in cameras, etc., these types of devices can play an important role expediting and streamlining the insurance underwriting process. As such, there is a need to provide systems which utilize such technology in the aforementioned investigative aspect of the insurance underwriting industry.

### SUMMARY

The present disclosure relates to a system and method for conducting on-site asset investigations for insurance underwriting. The system allows a user, such as an insurance agent, underwriting representative, or consumer to conduct an investigation into an asset to be insured while at the asset's location, using a mobile software application executing on a mobile computing device such as smart phone, tablet computer, etc. The mobile application allows the user to acquire information relating to the asset, such as a vehicle identification number (VIN), information corresponding to the vehicle, and photographs of the vehicle or other personal property to be insured, using the mobile computing device. The acquired information is transmitted to an underwriting computer server in communication with the mobile device, which processes the information and generates an underwriting report for the insurance carrier. The report can include information indicative of potential underwriting risk, such as the distance between the location where the images of the property were taken by the mobile computing device and the address of the property owner, as well as other risk-related information.

### BRIEF DESCRIPTION OF THE DRAWINGS

The foregoing features of the invention will be apparent from the following Detailed Description, taken in connection with the accompanying drawings, in which:

FIG. 1 is a diagram showing the system of the present disclosure for conducting on-site asset investigations for insurance underwriting;

FIG. 2 is a flowchart showing processing steps carried out by the system;

FIGS. 3A-3N are screenshots showing various user interface screens generated by the system; and

FIGS. 4A-4B show sample investigation reports generated by the system for use in insurance underwriting.

### DETAILED DESCRIPTION

The present disclosure relates to a system and method for conducting on-site asset investigations for insurance underwriting, as discussed in detail below in connection with FIGS. 1-4B.

FIG. 1 is a diagram illustrating the system 10 of the present disclosure. The system 10 allows for on-site inspection of any insurable asset, such as a vehicle, for insurance underwriting purposes. The system 10 includes one or more mobile computing devices 12, each executing an on-site underwriting software application 16 that allows an operator of the devices 12 to conduct an inspection and underwriting of an asset located at an asset location 14. The mobile computing devices 12 could include, but are not limited to, smart phones (e.g., APPLE IPHONE), table computers (e.g., APPLE IPAD), laptop computers, or other mobile computing devices. The mobile computing devices 12 communicate inspection and underwriting information captured at the asset location to an underwriting server 20 located remotely from the asset location 14, via a network 18 such as the Internet, a cellular data network (e.g., 3G and/or 4G cellular data network, such as Long-Term Evolution (LTE)). The underwriting server 20 stores the information in a database 22, and processes the information to generate an inspection/underwriting report that van be used by an insurer/underwriter in connection with insuring the asset at the asset location 14.

FIG. 2 is a flowchart showing processing steps 30 carried out by the system 10 for a vehicle. In step 32, a user of one of the mobile computing devices 12 of FIG. 1 scans a barcode corresponding to a vehicle identification number (VIN) of a vehicle, using a camera of the mobile computing device 12 (e.g., a camera of a smart phone or a table computer, etc.) and the on-site underwriting software application 16 executing on the mobile computing device 12. In step 34, the application 16 determines whether the VIN is valid. If a negative determination is made, step 32 is repeated. Otherwise, steps 36-38 occur, wherein the application 16 transmits the scanned VIN number to the server 20, and the server 20 obtains vehicle information corresponding to the scanned VIN number, e.g., by obtaining a corresponding record from the database 22 or from another data source in communication with the server 20. The vehicle information is then transmitted to the application 16, which displays the vehicle information on the mobile computing device 12. The user then reviews the vehicle information and confirms that the information corresponds to the vehicle at the location. In step 40, the application 16 allows the user to take one or more pictures of the vehicle using a camera of the mobile computing device 12. Then, in step 42, the application 16 displays the pictures taken by the user and allows the user to confirm that the pictures should be used (or, allows the user to re-take pictures, if desired).

In step 44, a determination is made as to whether additional information should be captured relating to the vehicle 16. If so, step 46 occurs, wherein the application 16 allows the user to capture additional information about the vehicle. Such information could include, but is not limited to, vehicle mileage as reflected on an odometer of the vehicle, or vehicle damage. Otherwise, step 48 occurs, wherein the captured information is transmitted back to the server 20. In step 50, the transmitted information, including the photos, are stored in the database 22 of the server 20. Then, in step 52, the server 20 processes the information and generates an underwriting report for use in future insurance activities relating to the insurable asset, or for other purposes. Then, in step 54, the report is delivered to the carrier for use in underwriting. The report could be electronically transmitted to the carrier and/or using the network 18 and the mobile computing device 12, and/or it could be delivered using other delivery methods such as by facsimile, regular mail, etc.

FIGS. 3A-3N are screenshots of user interface screens generated by the mobile application 16 executing on the mobile computing devices 12. As can be seen, the mobile application 16 provides a simple and easy-to-use graphical user interface that allows a user of the mobile device 12 to quickly conduct an inspection of an asset such as a vehicle, and to capture information about the vehicle for use in insurance underwriting. FIG. 3A shows a main screen of the mobile device 12, and the application 16 can be launched by touching the icon 60. Once launched, the application displays a home screen 62 as shown in FIG. 3B. The screen 62 includes buttons 64-68 for allowing the user to scan barcode information corresponding to the vehicle's VIN number (button 64), for taking one or more pictures of the vehicle (button 66), and for sending information via e-mail (button 68).

When the user taps on the button 64, the mobile application 16 displays the screens shown in FIGS. 3C-3F. In the screen shown in FIG. 3C, the user is prompted by the application 16 to locate the vehicle's VIN number and, one located, to click on the button 70 to scan a bar code corresponding to the VIN. As can be seen in FIG. 3C, the screen includes graphical and textual indicia identifying possible locations as to where the VIN could be located (e.g., near the dashboard or on the door frame of the vehicle), so as to assist the user in locating the VIN number. As shown in FIG. 3D, once the button 70 of FIG. 3C has been selected, the camera of the mobile device 12 is activated, and the user points the camera at the bar code. The application 16 then automatically scans the bar code once it is within full view of the camera of the mobile device 12. Then, as shown in FIG. 3E, the application 16 processes the scanned bar code to extract the vehicle's VIN number, and displays the VIN number screen field 72. This allows the user to confirm that the scanned VIN is correct, or to make manual corrections to the VIN if necessary, or to enter the VIN manually if the application is unable to successfully complete the scan. Once the VIN is confirmed, the screen of FIG. 3F is displayed, wherein the application 16 communicates the confirmed VIN to the server 20 to obtain vehicle information therefrom corresponding to the VIN (or from another data source), and displays the corresponding vehicle information. The user can click the “Next” button displayed in FIG. 3F to confirm that the vehicle information is correct. Otherwise, if the information is incorrect, the user can click the “Previous” button so that the user can re-attempt to obtain correct vehicle information (e.g., by re-scanning or re-entering the VIN).

When the correct VIN and corresponding vehicle information has been obtained, the application 16 displays the screens shown in FIGS. 3G-3K which allow the user to take pictures of the vehicle using the camera of the mobile device 12. As shown in FIG. 3G, the screen displayed thereon allows the user to select which views of the vehicle to take by clicking on the buttons 74a-74d. Such views include, but are not limited to, front view (button 74a), rear view (button 74b), left side view (button 74c), and right side view (button 74d). The user can then use on or more of the camera screens shown in FIGS. 3H-3K to take pictures of the vehicle at the corresponding views. The user can choose to accept a picture once it has been taken, or to re-take the picture if desired.

When the pictures of the vehicle have been taken, the mobile application 16 optionally allows the user to obtain additional information relating to the vehicle using the mobile device 12. Such information could include, but is not limited to vehicle mileage information, damage information, information about documents relating to the vehicle (e.g., vehicle title and insurance papers, etc. Such information could be entered textually by the user, and/or the user could take one or more photographs of such information using a camera of the mobile computing device. Further, as shown in FIG. 3L, the application 16 could display a screen which allows the user to enter the mileage of the vehicle as reflected on the vehicle's odometer. For verification purposes, the application 16 could require the user to take a picture of the vehicle's odometer (as shown in FIG. 3M), to guard against potential fraud (e.g., to guard against the user entering incorrect mileage information.

When all desired information has been captured, the application 16 displays the screen shown in FIG. 3N, which indicates a transaction ID and informs the user that a detailed report will be sent to the user's e-mail inbox. It is noted that the system could allow the user to specify one or more e-mail addresses to which an insurance underwriting report can be transmitted, for the vehicle. For example, the report could be sent to an insurance company or other third-party entity, and it could be sent to such destinations in multiple ways (e.g., by e-mail, network-to-network transmission, file transfer protocol (FTP) transmission, etc.). The application can send the report to a pre-defined e-mail address corresponding to a user account, if desired. The application 16 then transmits all of the captured information (including the photographs) to the server 20 for processing as discussed above in connection with FIG. 2.

FIGS. 4A-4B show insurance underwriting reports generated by the server 20. As can be seen, the reports include the photographs of the vehicle taken by the user of the mobile device 12, and include specific information such as the date of generation of the report, odometer reading, vehicle VIN, year of the vehicle, make of the vehicle, model of the vehicle, personal injury protection (PIP) and/or medical payment information relating to insurance of the vehicle, liability symbols, vehicle registration details, address of the vehicle owner, vehicle license plate type, vehicle registration state, and other information. Additionally, the report could include information about insurance risk flags, alerts regarding mail drop locations, anti-theft alerts, and other information.

Importantly, the system 10 can identify the location of where the images of the property were taken by the user of the mobile device 12, and can calculate the distance between that location and the address of the property's owner. Such information could be expressed as miles and displayed in the report (as shown in FIG. 4B). Such mileage can be indicative of potential insurance fraud, e.g., significant distances between the location where the images were taken and the location of the owner's address could indicate that the information being provided is potentially fraudulent. Additionally, the report could include information relating to insurance underwriting risks, including but not limited to the information as shown in FIG. 4A. Such information could include the foregoing distance information, an indication that the vehicle registration state does not match with the image location, image origination location, vehicle accident flags, vehicle salvage flags, and commercial registration information relating to the vehicle, if applicable.

It is noted that the processing steps discussed herein could be embodied as instructions stored in a non-transitory, computer-readable medium (such as non-volatile memory) and executed by one or more of the computing devices disclosed herein (including the mobile computing device 12 and the server 20). It is understood by one of ordinary skill in the art that such computing devices include central processing units (e.g., one or more microprocessors) which execute the foregoing instructions in order to provide the features recited herein. The instructions could be coded in any suitable high- or low-level programming languages, such as C, Objective C, C++, Java, Flash, or any other suitable programming languages without departing from the spirit or scope of the present invention.

Also, while the foregoing discussion focused on use of the present invention in connection with conducting on-site investigations relating to vehicles, it is to be understood that the present invention could be utilized in connection with conducting investigations of other assets, such as residences, structures, boats, scheduled personal property, or other assets.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected by way of Letters Patent is set forth in the following claims.

What is claimed is:

1. A system for conducting an on-site investigation of an asset, comprising:
a mobile computing device having a processor, a memory, and a camera in communication with the processor; and
an underwriting software application stored in the memory of the mobile computing device which, when executed by the processor, causes the mobile computing device to: (i) capture an indicia on the asset using the camera of the mobile computing device; (ii) transmit the indicia to an underwriting server in communication with the mobile computing device; (iii) receive information describing the asset from the underwriting server; (iv) display the information on a display of the mobile computing device; (v) receive a confirmation from a user of the mobile computing device that the information corresponds to the asset; and (vi) transmit the confirmation to the underwriting server for subsequent processing of the confirmation by the underwriting server and generation of an underwriting report for the asset.

2. The system of claim 1, wherein the asset comprises a vehicle.

3. The system of claim 1, wherein the indicia comprises a bar code captured by the camera, the bar code corresponding to a vehicle identification number.

4. The system of claim 3, wherein the underwriting software application causes the mobile computing device to display the vehicle identification to the user for confirmation by the user.

5. The system of claim 1, wherein the information about the asset comprises one or more of a vehicle identification number, a year of manufacture of the asset, a manufacturer of the asset, or a model of the asset.

6. The system of claim 1, wherein the underwriting software application allows the user to take one or more pictures of the asset using the camera.

7. The system of claim 6, wherein the mobile computing device transmits the one or more pictures of the asset to the underwriting server for inclusion in the underwriting report.

8. The system of claim 6, wherein the mobile computing device identifies a location where the one or more pictures of the asset has been taken.

9. The system of claim 8, wherein the system processes the location to identify whether the information relating to the asset is fraudulent.

10. The system of claim 1, wherein the underwriting software application allows the user to specify a destination to which the underwriting report is to be sent.

11. A method for conducting an on-site investigation of an asset, comprising the steps of:
allowing a user of a mobile computing device to capture an indicia on an asset using a camera of the mobile computing device;
transmitting the indicia to an underwriting server in communication with the mobile computing device;
receiving information describing the asset from the underwriting server;
displaying the information on a display of the mobile computing device;
receiving a confirmation from the user of the mobile computing device that the information corresponds to the asset; and
transmitting the confirmation to the underwriting server for subsequent processing of the confirmation by the underwriting server and generation of an underwriting report for the asset.

12. The method of claim 11, wherein the step of capturing the indicia comprises capturing a bar code using the camera, the bar code corresponding to a vehicle identification number.

13. The method of claim 12, further comprising the vehicle identification to the user for confirmation by the user.

14. The method of claim 11, wherein the step of receiving the information from the underwriting server comprises receiving one or more of a vehicle identification number, a year of manufacture of the asset, a manufacturer of the asset, or a model of the asset.

15. The method of claim 11, further comprising allowing the user to take one or more pictures of the asset using the camera.

16. The method of claim 15, further comprising transmitting the one or more pictures of the asset to the underwriting server for inclusion in the underwriting report.

17. The method of claim 15, further comprising identifying a location where the one or more pictures of the asset has been taken.

18. The method of claim 17, further comprising processing the location to identify whether the information relating to the asset is fraudulent.

19. The method of claim 11, further comprising allowing the user to specify an e-mail address to which the underwriting report is to be sent.

20. A non-transitory, computer-readable medium having computer-readable instructions stored thereon which, when executed by a mobile computing device having a processor and a camera, cause the mobile computing device to perform the steps of:
allowing a user of the mobile computing device to capture an indicia on an asset using the camera of the mobile computing device;
transmitting the indicia to an underwriting server in communication with the mobile computing device;
receiving information describing the asset from the underwriting server;
displaying the information on a display of the mobile computing device;
receiving a confirmation from the user of the mobile computing device that the information corresponds to the asset; and
transmitting the confirmation to the underwriting server for subsequent processing of the confirmation by the underwriting server and generation of an underwriting report for the asset.

21. The computer-readable medium of claim 20, wherein the step of capturing the indicia comprises capturing a bar code using the camera, the bar code corresponding to a vehicle identification number.

22. The computer-readable medium of claim 21, further comprising instructions for displaying the vehicle identification to the user for confirmation by the user.

23. The computer-readable medium of claim 20, wherein the step of receiving the information from the underwriting server comprises receiving one or more of a vehicle identification number, a year of manufacture of the asset, a manufacturer of the asset, or a model of the asset.

24. The computer-readable medium of claim 20, further comprising instructions for allowing the user to take one or more pictures of the asset using the camera.

25. The computer-readable medium of claim 24, further comprising instructions for transmitting the one or more pictures of the asset to the underwriting server for inclusion in the underwriting report.

26. The computer-readable medium of claim 24, further comprising instructions for identifying a location where the one or more pictures of the asset has been taken.

27. The computer-readable medium of claim 20, further comprising instructions for processing the location to identify whether the information relating to the asset is fraudulent.

28. The computer-readable medium of claim 20, further comprising instructions for allowing the user to specify an e-mail address to which the underwriting report is to be sent.
